(19) United States
(12) Patent Application Publication
(10) Pub. No.: US 2025/0317605 A1
(43) Pub. Date: Oct. 9, 2025

(54) PROGRESSIVE GENERATIVE FACE VIDEO COMPRESSION WITH BANDWIDTH INTELLIGENCE

(71) Applicant: Alibaba (China) Co., Ltd., Hangzhou (CN)

(72) Inventors: Bolin Chen, Beijing (CN); Yan Ye, San Diego, CA (US); Jie Chen, Beijing (CN); Ru-Ling Liao, Sunnyvale, CA (US); Shiqi Wang, Hong Kong (CN)

(21) Appl. No.: 19/096,546

(22) Filed: Mar. 31, 2025

Related U.S. Application Data
(60) Provisional application No. 63/631,883, filed on Apr. 9, 2024.

(51) Int. Cl. H04N 19/91; G06T 3/40; G06T 7/20; G06V 10/44; G06V 10/771; H04N 19/124; H04N 19/184

(52) U.S. Cl. CPC H04N 19/91; G06T 3/40; G06T 7/20; G06V 10/44; G06V 10/771; H04N 19/124; H04N 19/184

(57) ABSTRACT

Methods and systems implement a progressive generative face video compression framework with bandwidth intelligence, hierarchically accommodating variable bitrate video communication and implementing high-fidelity face reconstruction towards overall bandwidth coverage. Heterogeneous-granularity facial description regularizes long-term dependencies between video frames and compensates for motion estimation errors caused by compact representations of motion information, achieving satisfactory human visual perception and bandwidth intelligence in a progressive fashion. High efficiency for heterogeneous-granularity signal compression is achieved by two different entropy-based signal compression methods: heterogeneous-granularities feature representation from the key-reference frame as hyperpriors to optimize the entropy model for compressing heterogeneous-granularity feature from subsequent inter frames, and a feature difference operation for heterogeneous-granularities feature representation between key-reference and subsequent inter frames, such that the entropy model only compresses heterogeneous-granularities feature residual for redundancy reduction.

### PRIORITY

This patent application claims priority to U.S. Provisional Patent Application No. 63/631,883, filed on Apr. 9, 2024, entitled “A Progressive Face Video Compression Framework with Bandwidth Intelligence,” and is fully incorporated by reference herein.

### BACKGROUND

Techniques for compression of video data have grown to include generative representation powered by Artificial Intelligence Generated Content (“AIGC”) models, with the aim of substantially improving bitrate transmission efficiency over signal-level coding. For decades, face video coding technologies in particular have been hindered by subpar face analysis and synthesis. More recently, deep generative models have yielded learning-based face reenactment and animation models embodied by Generative Face Video Compression (“GFVC”), wherein encoder architecture employs an analysis model to effectively characterize complex facial motions, while decoder architecture utilizes a synthesis model to reconstruct high-quality face video. Pixel-level facial signal can be economically represented into compact representations, such as 2D landmarks, 2D keypoints, 3D keypoints, temporal trajectory feature, segmentation map and facial semantics. Such implementations aim to enable transmission of face-to-face video communications under ultra-low bitrates.

However, in general, generative models focus on generating visually rich textures given features, while compression, in contrast, aims to reconstruct a given video with the allocated bitrate. While generative models prioritize the quality of the generated content, compression techniques prioritize efficient representation and reconstruction of the original video within the available bitrate. Therefore, in the context of learning-based compression, the inference process inherently incorporates the ground-truth video content in encoding. There remains substantial room to design innovative and tailored generative techniques specifically for compression.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example block diagram of an encoding process according to an example embodiment of the present disclosure.

FIG. 2 illustrates an end-to-end video compression deep learning model that jointly optimizes components for video compression.

FIG. 3 illustrates a flowchart of a deep learning model-based video generative compression First Order Motion Model.

FIG. 4 illustrates a flowchart of a deep learning model-based video generative compression model based on compact feature representation.

FIG. 5 illustrates a progressive generative face video compression framework with bandwidth intelligence according to example embodiments of the present disclosure.

FIGS. 6A and 6B illustrate flowcharts of an optimized entropy model for compression of a heterogeneous-granularity auxiliary signal.

FIG. 7 illustrates an example system for implementing the processes and methods described herein for implementing progressive generative face video compression framework with bandwidth intelligence.

### DETAILED DESCRIPTION

Systems and methods discussed herein are directed to implementing a progressive generative face video compression framework with bandwidth intelligence. High efficiency for heterogeneous-granularity signal compression is achieved by two different entropy-based signal compression methods: heterogeneous-granularities feature representation from the key-reference frame as hyperpriors to optimize the entropy model for compressing heterogeneous-granularity feature from subsequent inter frames, and a feature difference operation for heterogeneous-granularities feature representation between key-reference and subsequent inter frames, such that the entropy model only compresses heterogeneous-granularities feature residual for redundancy reduction.

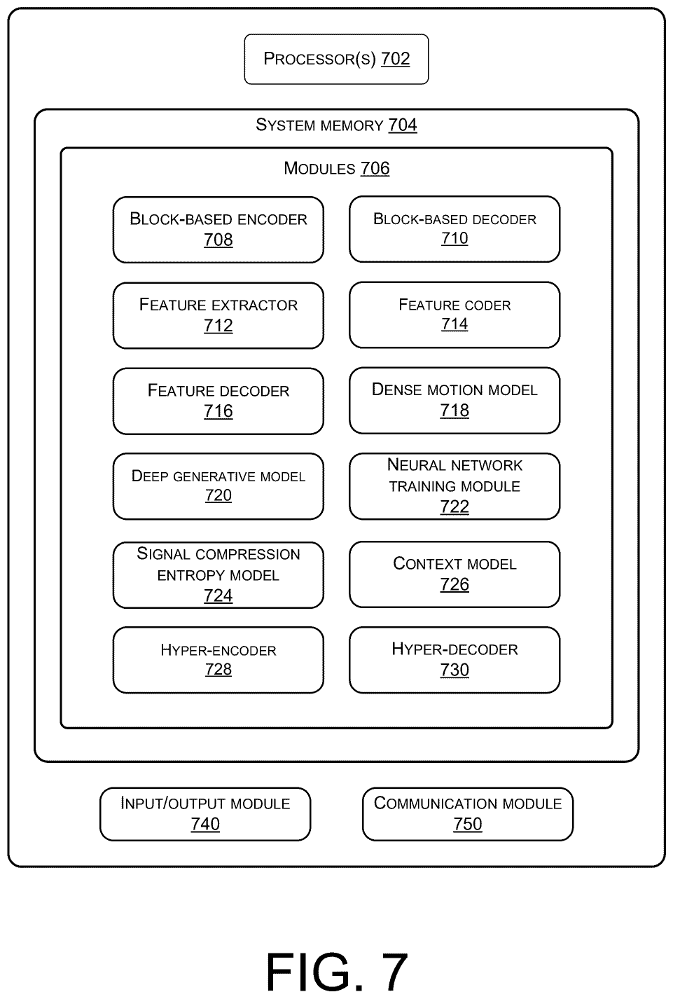

In accordance with the H.264/AVC (Advanced Video Coding), H.265/HEVC (High Efficiency Video Coding), and Versatile Video Coding (“VVC”) standards, a block-based hybrid video coding framework is implemented to exploit the spatial redundancy, temporal redundancy and information entropy redundancy in video. A computing system includes at least one or more processors and a computer-readable storage medium communicatively coupled to the one or more processors. The computer-readable storage medium is a non-transient or non-transitory computer-readable storage medium, as defined subsequently with reference to FIG. 7, storing computer-readable instructions. At least some computer-readable instructions stored on a computer-readable storage medium are executable by one or more processors of a computing system to configure the one or more processors to perform associated operations of the computer-readable instructions, including at least operations of an encoder as described by the above-mentioned standards, and operations of a decoder as described by the above-mentioned standards. Some of these encoder operations and decoder operations according to the above-mentioned standard are subsequently described in further detail, though these subsequent descriptions should not be understood as exhaustive of encoder operations and decoder operations according to the above-mentioned standards. Subsequently, a “block-based encoder” and a “block-based decoder” shall describe the respective computer-readable instructions stored on a computer-readable storage medium which configure one or more processors to perform these respective operations (which can be called, by way of example, “reference implementations” of an encoder or a decoder).

Moreover, according to example embodiments of the present disclosure, a block-based encoder and a block-based decoder further include computer-readable instructions stored on a computer-readable storage medium which are executable by one or more processors of a computing system to configure the one or more processors to perform operations not specified by the above-mentioned standards. A block-based encoder should not be understood as limited to operations of a reference implementation of an encoder, but including further computer-readable instructions configuring one or more processors of a computing system to perform further operations as described herein. A block-based decoder should not be understood as limited to operations of a reference implementation of a decoder, but including further computer-readable instructions configuring one or more processors of a computing system to perform further operations as described herein.

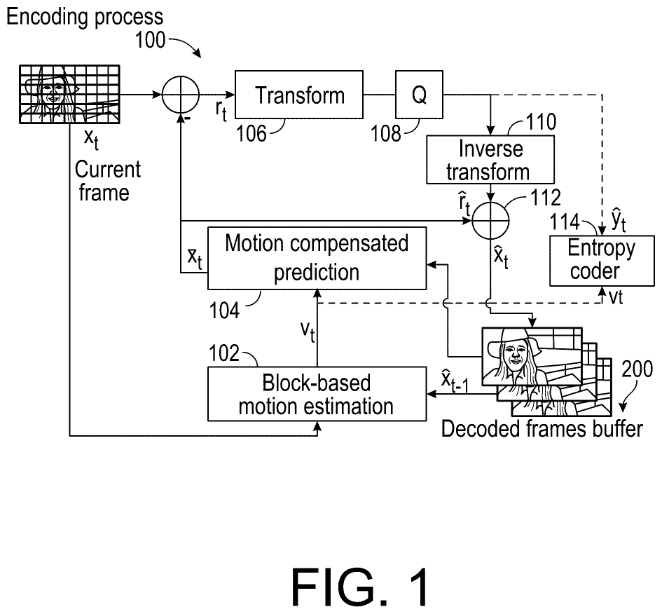

FIG. 1 illustrates an example block diagram of an encoding process 100 according to an example embodiment of the present disclosure. The encoding process 100 and a decoding process follow the predict-transform architecture, wherein the video compression encoder generates the bitstream based on the input current frames, and the decoder reconstructs the video frames based on the received bitstreams.

In an encoding process 100, a block-based encoder configures one or more processors of a computing system to receive, as input, one or more input frames from an image source. A block-based encoder encodes a frame (a frame being encoded being called a “current frame,” as distinguished from any other frame received from an image source) by configuring one or more processors of a computing system to partition the original frame into units and subunits according to a partitioning structure. A block-based encoder configures one or more processors of a computing system to subdivide the input frame x_t is split into a set of blocks, i.e., square regions, of the same size (e.g., 8×8).

A block-based encoder configures one or more processors of a computing system to perform motion estimation 102: estimating the motion between the current frame xₜ and the previous reconstructed frame \hat{x}ₜ₋₁. The corresponding motion vector vₜ for each block is obtained.

A block-based encoder configures one or more processors of a computing system to perform motion compensated prediction 104 upon blocks of a current frame. Motion compensation causes frame data of a current frame (and blocks thereof) using motion information and prediction units (“PUs”), rather than pixel data, according to intra prediction or inter prediction. The predicted frame x̅ₜ is obtained by copying the corresponding pixels in the previous reconstructed frame to the current frame based on the motion vector vₜ obtained in step 102. The difference rₜ between the original frame xₜ and the predicted frame x̅ₜ is called the prediction residual, or “residual” for brevity, and is obtained as rₜ=xₜ−x̅ₜ.

Motion information refers to data describing motion of a block structure of a frame or a unit or subunit thereof, such as motion vectors and references to blocks of a current frame or of a reference frame. PUs may refer to a unit or multiple subunits corresponding to a block structure among multiple block structures of a frame, wherein blocks are partitioned based on the frame data and are coded according to block-based coding. Motion information corresponding to a PU may describe motion prediction as encoded by a block-based encoder as described herein.

According to intra prediction, one or more processors of a computing system are configured to encode a block by references to motion information and PUs of one or more other blocks of the same frame. According to intra prediction coding, one or more processors of a computing system perform an intra prediction (also called spatial prediction) computation by coding motion information of the current block based on spatially neighboring samples from spatially neighboring blocks of the current block.

According to inter prediction, one or more processors of a computing system are configured to encode a block by references to motion information and PUs of one or more other frames. One or more processors of a computing system are configured to store one or more previously coded and decoded frames in a reference frame buffer for the purpose of inter prediction coding; these stored frames are called reference frames.

One or more processors are configured to perform an inter prediction (also called temporal prediction or motion compensated prediction) computation by coding motion information of the current block based on samples from one or more reference frames.

Based on a prediction residual, a block-based encoder further implements a transform 106. One or more processors of a computing system are configured to perform a transform operation on the residual by a matrix arithmetic operation to compute an array of coefficients (which can be referred to as “residual coefficients,” “transform coefficients,” and the like), thereby encoding a current block as a transform block (“TB”). Transform coefficients may refer to coefficients representing one of several spatial transformations, such as a diagonal flip, a vertical flip, or a rotation, which may be applied to a sub-block.

It should be understood that a coefficient can be stored as two components, an absolute value and a sign, as shall be described in further detail subsequently.

Sub-blocks of CUs, such as PUs and TBs, can be arranged in any combination of sub-block dimensions as described above. A block-based encoder configures one or more processors of a computing system to subdivide a CU into a residual quadtree (“RQT”), a hierarchical structure of TBs. The RQT provides an order for motion prediction and residual coding over sub-blocks of each level and recursively down each level of the RQT.

A linear transform (e.g., DCT) is used before quantization for better compression performance.

A block-based encoder further implements a quantization (“Q”) 108. One or more processors of a computing system are configured to perform a quantization operation on the residual coefficients by a matrix arithmetic operation, based on a quantization matrix and the QP as assigned above. Residual coefficients falling within an interval are kept, and residual coefficients falling outside the interval step are discarded. Thus, the residual rₜ is quantized to ŷₜ.

A block-based encoder further implements an inverse transform 110. One or more processors of a computing system are configured to perform an inverse transform operation on the quantized residual coefficients, by matrix arithmetic operations which are the inverse of the quantization operation and transform operation as described above. The inverse quantization operation and the inverse transform operation yield a reconstructed residual. Thus, the quantized result ŷₜ is inverse transformed to yield the reconstructed residual \hat{r}ₜ.

A block-based encoder further implements an adder 112. One or more processors of a computing system are configured to perform an addition operation by adding a prediction block and a reconstructed residual, outputting a reconstructed block. Thus, the reconstructed frame \hat{x}ₜ is obtained by adding x̅ₜ and rₜ, i.e. \hat{x}ₜ=\hat{r}ₜ+x̅ₜ.

A block-based encoder further configures one or more processors of a computing system to output a filtered reconstructed block to a decoded frame buffer 200. A decoded frame buffer stores reconstructed frames which are used by one or more processors of a computing system as reference frames in coding frames other than the current frame, as described above with reference to inter prediction. Thus, the reconstructed frame will be used by the (t−1)ₜₕ frame at step 102 for motion estimation.

A block-based encoder further implements an entropy coder 114. One or more processors of a computing system are configured to perform entropy coding, wherein, according to the Context-Sensitive Binary Arithmetic Codec (“CABAC”), symbols making up quantized residual coefficients are coded by mappings to binary strings (subsequently “bins”), which can be transmitted in an output bitstream at a compressed bitrate. The symbols of the quantized residual coefficients which are coded include absolute values of the residual coefficients (these absolute values being subsequently referred to as “residual coefficient levels”).

The entropy coder configures one or more processors of a computing system to code residual coefficient levels of a block; bypass coding of residual coefficient signs and record the residual coefficient signs with the coded block; record coding parameter sets such as coding mode, a mode of intra prediction or a mode of inter prediction, and motion information coded in syntax structures of a coded block (such as a picture parameter set (“PPS”) found in a picture header, as well as a sequence parameter set (“SPS”) found in a sequence of multiple pictures); and output the coded block. Thus, the motion vector vₜ and the quantized result ŷₜ are both encoded into bits by the entropy coding method and sent to a decoder.

A block-based encoder configures one or more processors of a computing system to output a coded picture, made up of coded blocks from the entropy coder 114. The coded picture is output to a transmission buffer, where it is ultimately packed into a bitstream for output from the block-based encoder. The bitstream is written by one or more processors of a computing system to a non-transient or non-transitory computer-readable storage medium of the computing system, for transmission.

In a decoding process, a block-based decoder configures one or more processors of a computing system to receive, as input, one or more coded pictures from a bitstream.

A block-based decoder implements an entropy decoder. One or more processors of a computing system are configured to perform entropy decoding, wherein, according to CABAC, bins are decoded by reversing the mappings of symbols to bins, thereby recovering the entropy-coded quantized residual coefficients. The entropy decoder outputs the quantized residual coefficients, outputs the coding-bypassed residual coefficient signs, and also outputs the syntax structures such as a PPS and a SPS.

A block-based decoder further implements an inverse quantization and an inverse transform. One or more processors of a computing system are configured to perform an inverse quantization operation and an inverse transform operation on the decoded quantized residual coefficients, by matrix arithmetic operations which are the inverse of the quantization operation and transform operation as described above. The inverse quantization operation and the inverse transform operation yield a reconstructed residual.

Furthermore, based on coding parameter sets recorded in syntax structures such as PPS and a SPS by the entropy coder (or, alternatively, received by out-of-band transmission or coded into the decoder), and a coding mode included in the coding parameter sets, the block-based decoder determines whether to apply intra prediction (i.e., spatial prediction) or to apply motion compensated prediction (i.e., temporal prediction) to the reconstructed residual.

In the event that the coding parameter sets specify intra prediction, the block-based decoder configures one or more processors of a computing system to perform intra prediction using prediction information specified in the coding parameter sets. The intra prediction thereby generates a prediction signal.

In the event that the coding parameter sets specify inter prediction, the block-based decoder configures one or more processors of a computing system to perform motion compensated prediction using a reference picture from a decoded frames buffer 200. The motion compensated prediction thereby generates a prediction signal.

A block-based decoder further implements an adder. The adder configures one or more processors of a computing system to perform an addition operation on the reconstructed residuals and the prediction signal, thereby outputting a reconstructed block.

A block-based decoder further configures one or more processors of a computing system to output a filtered reconstructed block to the decoded frame buffer 200. As described above, a decoded frame buffer 200 stores reconstructed pictures which are used by one or more processors of a computing system as reference pictures in coding pictures other than the current picture, as described above with reference to motion compensated prediction.

A block-based decoder further configures one or more processors of a computing system to output reconstructed pictures from the decoded frame buffer 200 to a user-viewable display of a computing system, such as a television display, a personal computing monitor, a smartphone display, or a tablet display.

Therefore, as illustrated by an encoding process 100 and a decoding process as described above, a block-based encoder and a block-based decoder each implements motion prediction coding in accordance with the above-mentioned standards. A block-based encoder and a block-based decoder each configures one or more processors of a computing system to generate a reconstructed picture based on a previous reconstructed picture of a decoded frame buffer 200 according to motion compensated prediction as described by the above-mentioned standards, wherein the previous reconstructed picture serves as a reference picture in motion compensated prediction as described herein.

Deep learning models have been proposed to replace or enhance individual video coding tools, including intra/inter prediction, entropy coding and in-loop filtering. Moreover, deep learning models have been proposed to provide jointly optimized end-to-end image and video compression pipelines, rather than one particular module thereof.

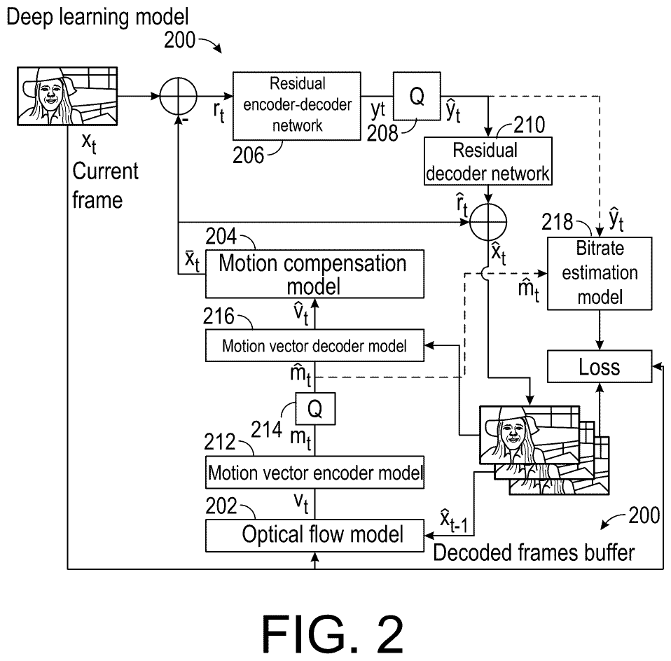

By way of example, FIG. 2 illustrates an end-to-end video compression deep learning model 200 that jointly optimizes components for video compression, such as motion estimation, motion compression, and residual compression. Learning-based optical flow estimation configures one or more processors of a computing system to obtain motion information and reconstruct the current frames. Two auto-encoder style neural networks configure one or more processors of a computing system to compress the corresponding motion and residual information. The modules are jointly learned through a single loss function, in which they collaborate by considering the trade-off between reducing the number of compression bits and improving quality of the decoded video.

A learning model can include one or more sets of computer-readable instructions executable by one or more processors of a computing system to perform tasks that include processing input and various parameters of the model, and outputting results. A learning model can be, for example, a layered model such as a deep neural network, which can have a fully-connected structure, can have a feedforward structure such as a convolutional neural network (“CNN”), can have a backpropagation structure such as a recurrent neural network (“RNN”), or can have other architectures suited to the computation of particular tasks. Generally, any layered model having multiple layers between an input layer and output layer is a deep neural network (“DNN”).

There are one-to-one correspondences between the video compression process illustrated by FIG. 1 and the end-to-end deep learning model-based process illustrated by FIG. 2. Relationships and differences are introduced as follows:

To perform motion estimation and compression, an optical flow model 202 (such as, by way of example, a CNN) configures one or more processors of a computing system to estimate the optical flow, which is considered as motion information vₜ. Instead of directly encoding the raw optical flow values, an MV encoder-decoder network configures one or more processors of a computing system to compress and decode the optical flow values, in which the quantized motion representation is denoted as \hat{m}ₜ. Then, the corresponding reconstructed motion information \hat{v}ₜ can be decoded by using the MV decoder net.

To perform motion compensation, a motion compensation model 204 configures one or more processors of a computing system to obtain the predicted frame xₜ based on the optical flow yielded by the optical flow model 202.

To perform transforms, quantization and inverse transforms, rather than a linear transform, a highly non-linear residual encoder-decoder network 206 configures one or more processors of a computing system to non-linearly map the residual n, to the representation yₜ. Then, yₜ is quantized to ŷₜ at quantization 208. The quantized representation ŷₜ is input to the residual decoder network to obtain the reconstructed residual \hat{r}ₜ.

To perform entropy coding, at the testing stage, a motion vector encoder model 212 configures one or more processors of a computing system to code the motion representation \hat{m}ₜ (quantized at quantization 214) and the residual representation ŷₜ into bits and input the coded bits to a motion vector decoder model 216. At the training stage, to estimate the number of bits cost, a bitrate estimation model 218 configures one or more processors of a computing system to obtain the probability distribution of each symbol in \hat{m}ₜ and ŷₜ.

Frame reconstruction proceeds as described above with reference to FIG. 1.

Further proposals of deep generative models implement Variational Auto-Encoding (“VAE”) and Generative Adversarial Networks (“GAN”) to seek further performance improvement. “fs-vid2vid” or “FV2V” implements 3D keypoint representation driving a generative model for rendering the target frame. First Order Motion Model (“FOMM”) implements a mobile-compatible video chat system. Compact feature learning (“CFTE”) implements an end-to-end talking-head video compression framework for talking face video compression under ultra-low bandwidth. The 3D morphable model (“3DMM”) template implements facial semantics to characterize facial video and implement face manipulation for facial video coding.

Table 1 below further summarizes compact representations for generative face video compression algorithms. Face images exhibit strong statistical regularities, which can be economically characterized with 2D landmarks, 2D keypoints, region matrix, 3D keypoints, compact feature matrix and facial semantics. Such facial description strategies can lead to reduced coding bit-rate and improve coding efficiency, thus being applicable to video conferencing and live entertainment.

| Compact | |
|---|---|
| representation | Description |
| 2D landmarks | VSBNet is a representative model which can utilize 98 groups of 2D facial landmarks [symbol] ^{2×98} |
| | to depict the key structure information of human face, where the total number of encoding |
| | parameters for each inter frame is 196. |
| 2D keypoints and | FOMM is a representative model which adopts 10 groups of learned 2D keypoints |
| affine | [symbol] ^{2×10} along with their local affine transformations [symbol] ^{2×2×10} to characterize complex |
| transformation | motions. The total number of encoding parameters for each inter frame is 60. |
| matrix | |
| Region matrix | Motion representations for articulated animation (“MRAA”) is a representative model which |
| | extracts consistent regions of talking face to describe locations, shape, and pose, mainly |
| | represented with shift matrix [symbol] ^{2×10}, covar matrix [symbol] ^{2×2×10} and affine matrix [symbol] ^{2×2×10}. As |
| | such, the total number of encoding parameters for each inter frame is 100. |
| 3D keypoints | Face_vid2vid is a representative model which can estimate 12-dimension head parameters |
| | (i.e., rotation matrix [symbol] ^{3×3} and translation parameters [symbol] ^{3×1}) and 15 groups of learned 3D |
| | keypoint perturbations [symbol] ^{3×15} due to facial expressions, where the total number of encoding |
| | parameters for each inter frame is 57. |
| Compact feature | CFTE is a representative model which can model the temporal evolution of faces into |
| matrix | learned compact feature representation with the matrix [symbol] ^{4×4}, where the total number of |
| | encoding parameters for each inter frame is 16. |
| Facial semantics | Interactive Face Video Coding (“IFVC”) is a representative model which adopts a collection |
| | of transmitted facial semantics to represent the face frame, including mouth parameters [symbol] ⁶, |
| | eye parameter [symbol] ¹, rotation parameters [symbol] ³, translation parameters [symbol] ³ and location parameter |
| | [symbol] ¹. Totally, the number of encoding parameters for each inter frame is 14. |

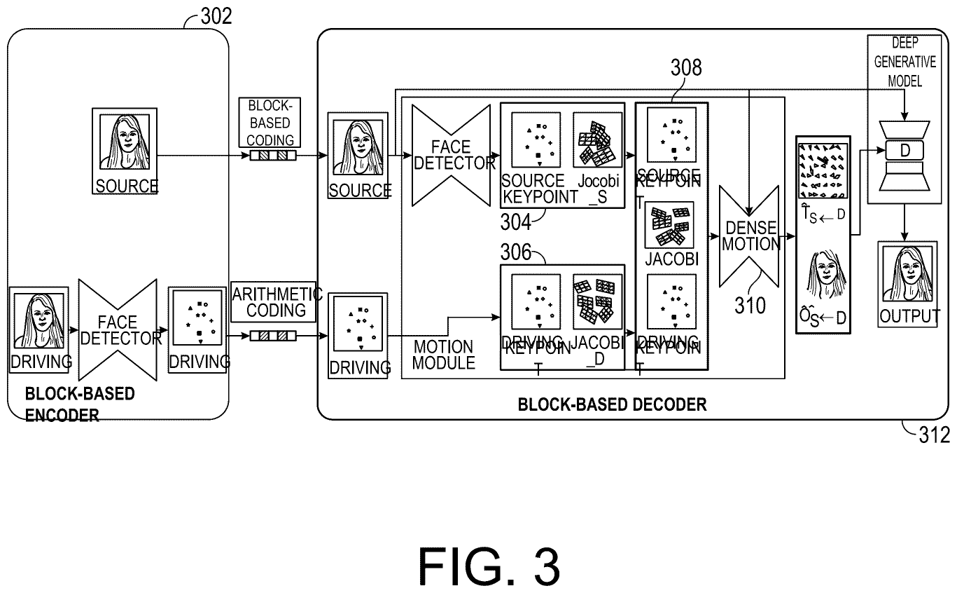

FIG. 3 illustrates a flowchart of a deep learning model-based video generative compression FOMM. An FOMM configures one or more processors of a computing system to deform a reference source frame to follow the motion of a driving video, and applies this to face videos in particular. The FOMM of FIG. 3 implements an encoder-decoder architecture with a motion transfer component.

The encoder configures one or more processors of a computing system to encode the source frame by a block-based image or video compression method, such as HEVC/VVC or JPEG/BPG. As illustrated in FIG. 3, a block-based encoder 302 as described above with reference to FIG. 1 configures one or more processors of a computing system to compress the source frame according to a block-based video coding standard, such as VVC as illustrated herein.

One or more processors of a computing system are configured to learn a keypoint extractor using an equivariant loss, without explicit labels. The keypoints (x, y) collectively represent points of a feature map having highest visual interest. A source keypoint extractor 304 and a driving keypoint extractor 306 respectively configure one or more processors of a computing system to compute two sets of ten learned keypoints for the source and driving frames. A Gaussian mapping operation 308 configures one or more processors of a computing system to transform the learned keypoints from the feature map with the size of channel×64×64. Thus, every corresponding keypoint can represent feature information of different channels.

A dense motion network 310 configures one or more processors of a computing system to, based on the learned keypoints and the source frame, output a dense motion field and an occlusion map.

A block-based decoder 312 configures one or more processors of a computing system to generate an image from the warped map.

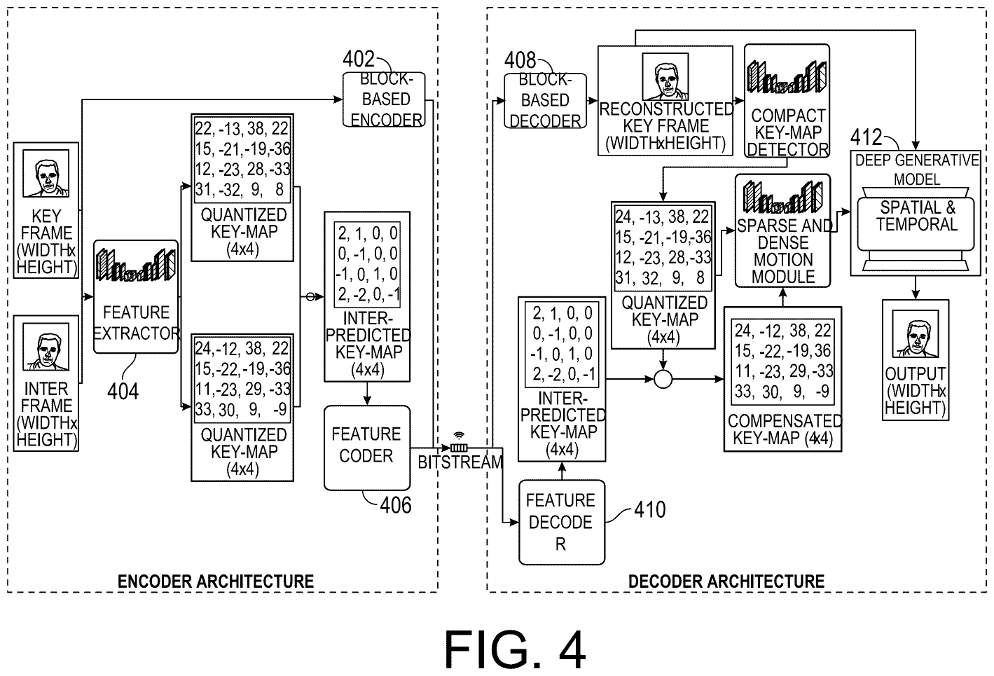

FIG. 4 illustrates a flowchart of a deep learning model-based video generative compression model based on compact feature representation, namely CFTE proposed by Chen et al. The model of FIG. 4 implements an encoder-decoder architecture which configures one or more processors of a computing system to process a sequence of frames, including a key frame and multiple subsequent inter frames.

Encoder architecture includes a block-based encoder 402, a feature extractor 404, and a feature coder 406.

The block-based encoder 402 configures one or more processors of a computing system to compress a key frame which represents human textures, herein according to a block-based video coding standard, such as VVC as illustrated herein.

The feature extractor 404 configures one or more processors of a computing system to represent each of the subsequent inter frames with a compact feature matrix with the size of 1×4×4. The size of compact feature matrix is not fixed and the number of feature parameters can also be increased or decreased based on available bitrate for transmission.

These extracted features are inter-predicted and quantized as described above with reference to FIG. 1. The feature coder 406 configures one or more processors of a computing system to entropy-code the residuals and transmit the coded residuals in a bitstream.

Decoder architecture includes a block-based decoder 408, a feature decoder 410, and a deep generative model 412.

The block-based decoder 408 configures one or more processors of a computing system to output a decoded key frame from the transmitted bitstream according to a block-based video coding standard, such as VVC as illustrated herein.

The feature decoder 410 configures one or more processors of a computing system to perform compact feature extraction on the decoded key frame to output features.

Subsequently, given the features from the key and inter frames, a relevant sparse motion field is calculated, facilitating the generation of the pixel-wise dense motion map and occlusion map.

The deep generative model 412 configures one or more processors of a computing system to output a video for display based on the decoded key frame, pixel-wise dense motion map and occlusion map with implicit motion field characterization, generating appearance, pose, and expression.

Lossy video compression based on Shannon's information theory aims to achieve minimal transmission bitrate (i.e., R) with the lowest possible distortion (i.e., D). Video compression can be generalized as a rate-distortion optimization regarding how to minimize overall cost J_{cost}, with a trade-off coefficient between R and D according to Equation 1 as follows,

$${J}_{cost} = D + λ R$$

where λ is the Lagrange multiplier representing the R-D relationship for a particular quality level.

Conventionally, increasing bits to represent and transmit the data is a trade-off to reduce visible distortion incurred from the compressed representation. However, this trade-off does not fully apply to existing generative compression algorithms relying on the straightforward application of generation models, such that superior RD trade-offs cannot be achieved in an overall bitrate coverage.

For generative compression algorithms, bitrate range is mainly adjusted based on compression degree and dynamic number of the key-reference frame (costed to provide vivid texture and color), while it is almost unaffected by compact representations of complex temporal motion. As a result, generative compression algorithms based on compact representation are typically forced to operate at one particular rate point.

Thus, in generative compression, RD balancing of the compression task becomes a constraint for the generation task. Robustness of generative models in scenes including complex motion and long-term dependencies is prone to yield artifacts, missing details and temporal inconsistency, so generating stable visual reconstruction, with precise motion and vivid texture, from compact feature representations remains a challenge.

Therefore, example embodiments of the present disclosure provide bandwidth intelligence for generative models and compression, to further improve picture quality in generative compression algorithms for face video communication. To overcome poor long-term dependencies and inaccurate motion estimation caused by the compact representations of GFVC algorithms, heterogeneous-granularity and bandwidth-intelligent facial feature representation are implemented to deliver heterogeneous-granularity signal to describe the important motion information (e.g., expression and headpose) and complex background changes in a scalable and flexible manner. Signals can be well-characterized at different granularity levels suited to different bandwidth limitations.

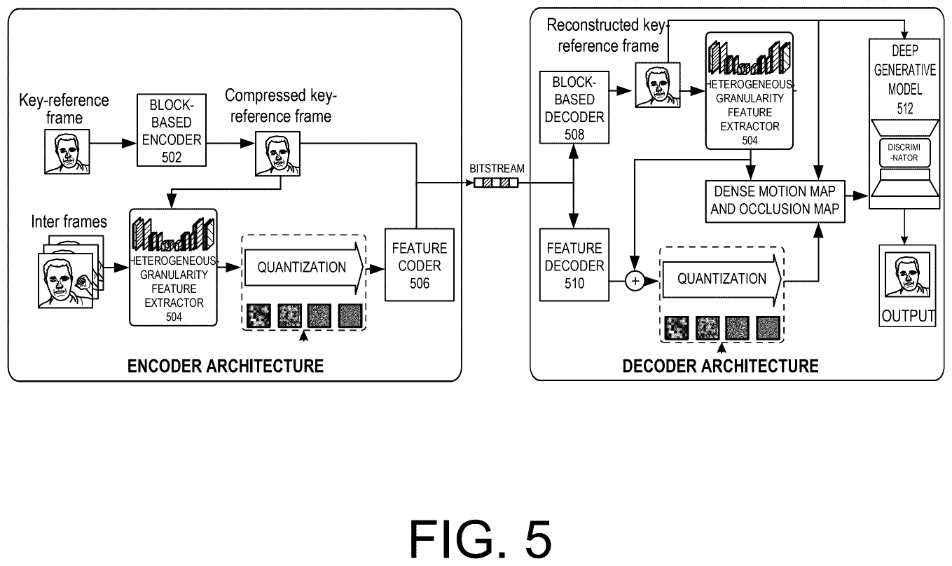

FIG. 5 illustrates a progressive generative face video compression framework with bandwidth intelligence according to example embodiments of the present disclosure. Herein, face frames are represented as latent code (i.e., keypoints, facial semantics and compact feature) and enriched signal (i.e., residual signal, segmentation map and dense flow) based on a prior distribution.

The progressive generative face video compression framework includes computer-readable instructions stored on a computer-readable storage medium which are executable by one or more processors of a computing system to configure the one or more processors to perform operations. According to example embodiments of the present disclosure, the progressive generative face video compression framework including a block-based encoder and a block-based decoder as described above with reference to FIG. 1; an optical flow model, a motion compensation model, a residual encoder-decoder network, and a motion vector encoder model as described above with reference to FIG. 2; a source keypoint extractor, a driving keypoint extractor, and a dense motion network as described above with reference to FIG. 3; and a feature extractor, a feature coder, a feature decoder, and a deep generative model as described above with reference to FIG. 4. Encoder architecture configures one or more processors of a computing system to characterizes face data with different-granularity facial signals, and selects, for different bandwidths, respective corresponding signals to transmit in a bitstream. Decoder architecture configures one or more processors of a computing system to receive the bitstream and, based on decoded facial signals, estimates complex motion and reconstructs high-quality faces.

FIG. 5 illustrates encoder architecture including a block-based encoder 502, a heterogeneous-granularity feature extractor 504, and a feature coder 506.

The block-based encoder 502 configures one or more processors of a computing system to compress a key frame which represents human textures, herein according to a block-based video coding standard, such as VVC as illustrated herein.

The heterogeneous-granularity feature extractor 504 configures one or more processors of a computing system to represent each of the subsequent inter frames with a feature having one of multiple heterogeneous granularities. The feature size can be chosen based on available bitrate for transmission in a bitstream.

A heterogeneous-granularity feature extractor should be understood as a learning model trained to extract human features of multiple different granularities, as described below, from input frames of a video sequence.

These extracted inter frame features are inter-predicted and quantized as described above with reference to FIG. 1. The feature coder 506 configures one or more processors of a computing system to entropy-code the residuals and transmit the coded residuals in a bitstream, as described subsequently with reference to a signal compression entropy model 600 or 650.

FIG. 5 illustrates decoder architecture including a block-based decoder 508, a heterogeneous-granularity feature extractor 504, a feature decoder 510, and a deep generative model 512.

The block-based decoder 508 configures one or more processors of a computing system to reconstruct a decoded key frame from the transmitted bitstream, herein according to a block-based video coding standard, such as VVC as illustrated herein.

The heterogeneous-granularity feature extractor 504 configures one or more processors of a computing system to perform heterogeneous-granularity feature extraction on the decoded key frame to output features having one among multiple heterogeneous granularities.

The feature decoder 510 configures one or more processors of a computing system to entropy-decode coded residuals transmitted in a bitstream and output decoded inter frame features, as described subsequently with reference to a signal compression entropy model 600 or 650.

Subsequently, given the features from the key and inter frames, a relevant sparse motion field is calculated, facilitating the generation of the pixel-wise dense motion map and occlusion map. By GFVC techniques such as FOMM as described above with reference to FIG. 3, CFTE as described above with reference to FIG. 4, and the like, one or more processors of a computing system are configured to output a dense motion map and an occlusion map based on the key-reference features and the inter frame features.

The deep generative model 512 configures one or more processors of a computing system to output a video for display based on the decoded key frame, pixel-wise dense motion map and occlusion map with implicit motion field characterization, generating appearance, pose, and expression.

More specifically, given frame pairs (e.g. the key frame K and the subsequent inter frames I₁) are input to a band-limited downsampler using an anti-aliasing mechanism and padding/convolution operations, which can better preserve the input signal when downsampling. Frame pairs are input to a UNet-like network to actualize the transformation from the input face image to a high-dimensional face feature map. In addition, richer convolutional architecture and Generalized Divisive Normalization (“GDN”) operations are further performed upon multi-level information and parametric nonlinear transformation from the high-dimensional face feature map, such that these extracted features can be further combined in a holistic manner and better compensate the information loss of compact representations. The process can follow Equation 2 below:

$${S}_{X} = {g}_{( conv , GDN )} ( {f}_{UNet} ( ν ( X , s ) ) )$$

where ν(·), f_{UNet}(·) and g_{(conv,GDN)}(·) denote signal down-sampling, high-dimensional feature learning and multi-level feature extraction processes, respectively. X can represent the key frame K or inter frame I₁, and s is the scale factor to determine the spatial size of face image. One or more processors of a computing system are configured to select a signal granularity of an original auxiliary facial signal S_{I}_{₁}; a higher or lower granularity of auxiliary facial signal S_{I}_{₁} can be selected randomly or selected according to respectfully higher or lower bitstream bandwidths. A selected granularity can be, by way of example but without limitation thereto, 64×64×1, 48×48×1, 32×32×1, 32×32×1, 24×24×1, 16×16×1, or 8×8×1.

Example embodiments of the present disclosure implement high-efficiency compression of heterogeneous-granularity feature representation by two mechanisms based on the above feature extraction.

According to example embodiments of the present disclosure, the auxiliary facial signal S_{I}_{₁} extracted from inter frame I₁ is a hyperprior for a probabilistic model. Based on this probabilistic structure, fully factorized priors are optimized to achieve high-efficiency compression of the auxiliary facial signal S_{I}_{₁}.

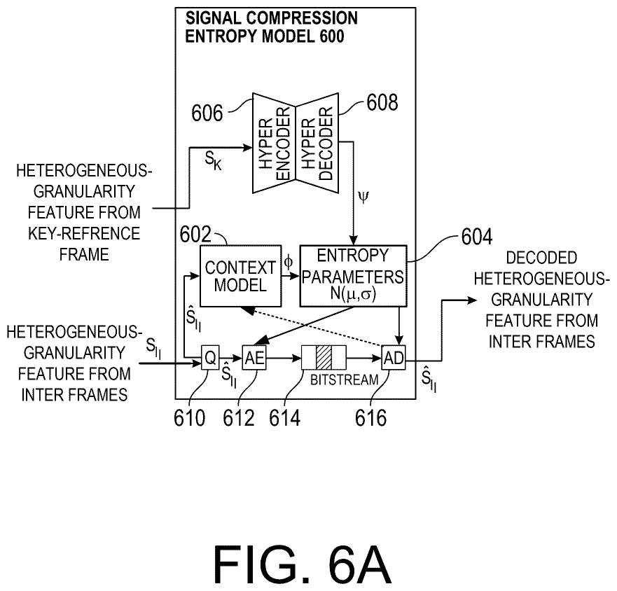

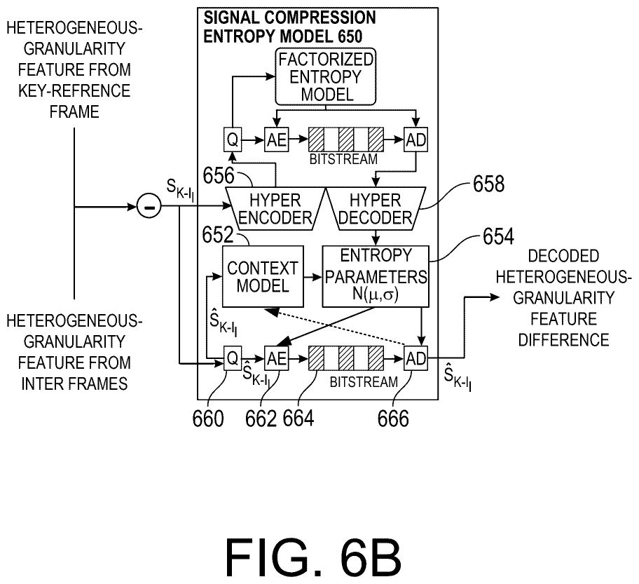

FIG. 6A illustrates a flowchart of an optimized signal compression entropy model 600 trained to perform compression of a heterogeneous-granularity auxiliary signal. The signal compression entropy model 600 includes a context model 602 (an autoregressive model over latents) and a hyper-network (hyper-encoder 606 and hyper-decoder 608) for S_{I}_{₁}. Hyperpriors of a probabilistic model are learned for entropy coding of the heterogeneous-granularity auxiliary facial signal S_{I}_{₁}, which can correct context-based predictions and reduce coding bits.

The signal compression entropy model 600 configures one or more processors of a computing system to input S_{I}_{₁} to quantizer 610 (“Q”), then input the quantized auxiliary facial signal [symbol] to arithmetic encoder 612 (“AE”) to produce the coded bitstream 614. The arithmetic decoder (“AD”) 616 configures one or more processors of a computing system to decode the coded bitstream 614 to yield a reconstructed auxiliary facial signal [symbol] . To improve compression performance, a Gaussian distribution 604, represented by entropy parameters μ and σ, is additionally introduced based on outputs of the context model 602 and the hyper-network, to assist decoding.

The hyperprior ψ can be predicted from the heterogeneous-granularity signal from key-reference frame S_{K} without any entropy coding process via the hyper-network Nₕₚ(·) and learned parameters θₕₚ according to Equation 3 as follows:

$$ψ = {N}_{hp} ( {S}_{K} ; {θ}_{hp} )$$

In addition, the causal context ϕ of quantized auxiliary facial signal [symbol] can be obtained via the context model 602 N_{cm}(·) and its learned parameters θ_{cm} according to Equation 4 as follows:

$$ϕ = {N}_{cn} ( ; {θ}_{cm} )$$

The mean and scale parameters μ and σ can be further conditioned on both the hyperprior ψ as well as the causal context ϕ, which is represented according to Equation 5 as follows:

$$μ , σ = {N}_{ep} ( ψ , ϕ ; {θ}_{ep} )$$

where θₑₚ is a function to learn entropy parameters.

Finally, the learned Gaussian distribution is input to the AD 616, and the AD 616 configures one or more processors of a computing system to predict, based on the learned Gaussian distribution, the reconstructed auxiliary facial signal [symbol] according to Equation 6 as follows:

$$( \vert {θ}_{hp} , {θ}_{cm} , {θ}_{ep} ) = ( 𝒩 ( μ , {σ}^{2} ) * 𝒰 ( - \frac{1}{2} , \frac{1}{2} ) ) ( )$$

FIG. 6B illustrates a flowchart of an optimized signal compression entropy model 650 trained to perform compression of a heterogeneous-granularity auxiliary facial signal. The signal compression entropy model 650 includes a context model 652 (an autoregressive model over latents), and a hyper-network (hyper-encoder 656 and hyper-decoder 658) for S_{I}_{₁}. An entropy model is trained with joint autoregressive and hierarchical priors to perform high-efficiency compression of the auxiliary facial signal S_{I}. The auxiliary facial signal S_{I}_{₁} extracted from inter frame I₁ is employed to achieve signal-level reduction with facial signal from key-reference frame S_{K} via signal difference S_{K-I}_{₁} according to Equation 7 as follows:

$${S}_{K - {I}_{1}} = {S}_{K} - {S}_{{I}_{1}}$$

The signal compression entropy model 654 configures one or more processors of a computing system to input S_{K-I}_{₁} to quantizer 660 and arithmetic encoder 662 to produce the coded bitstream 664. The arithmetic decoder (“AD”) 666 configures one or more processors of a computing system to decode the coded bitstream 664 to reconstruct the signal. To improve the compression performance, a Gaussian distribution 654, represented by entropy parameters μ and σ, is additionally introduced based on outputs of the context model 652 and the hyper-network, to assist decoding.

More specifically, the variance σ of the Gaussian distribution is also stored in the coded bitstream 664 via the hyper-encoder 656, quantizer 660 and arithmetic encoder 662. After that, the stored variance σ can be reconstructed through the arithmetic decoder 666 and hyper-decoder 658 when decoding the bitstream 664. On the other hand, the context model can facilitate the reconstruction of the mean value u, such that σ and μ are further combined to simulate the Gaussian distribution. The arithmetic decoder 666 configures one or more processors of a computing system to compute a reconstructed auxiliary facial signal Ŝ_{I}_{₁} based on the decoded S_{K-I}_{₁}, facial signal from key-reference frame S_{K}, and the Gaussian distribution as described by the entropy parameters μ and σ.

Based on the heterogeneous-granularity representation extracted from the key frame and the decoded reconstructed auxiliary facial signal from the bitstream, a pixel-wise dense motion map and occlusion map learning are implemented. First, a sparse motion field is obtained by applying the Gunnar Farneback optical flow algorithm (i.e., GF_{flow}(·)) to heterogeneous-granularity features of the key-reference frame and inter frames in the decoder (i.e., S_{K} and Ŝ_{I}_{₁}). Polynomials approximate the neighborhood information movement of each pixel between two frames, to implement global optical flow calculation. The sparse motion map (i.e., Mₛₚₐᵣₛₑ) between S_{K} and Ŝ_{I}_{₁} is given by Equation 8 as follows:

$${M}_{sparse} = {GF}_{flow} ( {S}_{K} , {\hat{S}}_{{I}_{1}} )$$

Mₛₚₐᵣₛₑ and the down-sampled key frame are input to a U-Net architecture, configuring one or more processors of a computing system to generate a coarse deformed frame (F_{cdf}) for fine motion field expression. In addition, S_{K} and Ŝ_{I}_{₁} are input to a trained up-sampling network, configuring one or more processors of a computing system to perform a scale transformation upon S_{K} and Ŝ_{I}_{₁}, and perform a difference operation to implicitly represent the change of motion information between S_{K} and S_{I}_{₁}, formulated by Equation 9 as follows:

$${Diff}_{〈 I , K 〉} = φ ( {S}_{K} ) - φ ( {\hat{S}}_{{I}_{1}} )$$

where φ(·) is a function representing the trained up-sampling network and Diff_{(I,K)} is the final upscaled feature difference.

Diff_{(I,K)} is concatenated with F_{cdf}, and the concatenation is input to a U-Net predictor, configuring one or more processors of a computing system to estimate a pixel-wise dense motion map (M_{dense}) and an occlusion map (M_{occlusion}). This operation is performed on implicit motion field characterization from the compact feature representation to contribute to inference of the final video, according to Equation 10 and Equation 11 as follows:

$${M}_{dense} = {P}_{1} ( {f}_{U - Net} ( concat ( {F}_{cdf} , {Diff}_{〈 I , K 〉} ) ) )$$

$${M}_{occlusion} = {P}_{2} ( {f}_{U - Net} ( concat ( {F}_{cdf} , {Diff}_{〈 I , K 〉} ) ) )$$

where P₁(·) and P₂(·) indicate two different predicted outputs.

To yield generative results in inferring reconstructed images, feature warping is performed on K based on M_{dense}. In the presence of occlusions in K, dense motion field M_{dense} may not be sufficient to yield realistic results (i.e., Î) compared to ground truth I. Occlusion map M_{occlusion} is applied to the warped K to mask out the feature map regions that should be inpainted. The overall process is described according to Equation 12 as follows:

$$\hat{I} = {M}_{occlusion} ⊙ {f}_{w} ( K , {M}_{dense} )$$

where f_{w} and ⊙ denote the back-warping operation and the Hadamard product, respectively. Finally, the transformed result Î is input to subsequent network layers of the generation model to, at which a discriminator configures one or more processors of a computing system to further render the key frame.

Self-supervised training is performed during training of respective models of the optimized entropy models of FIGS. 6A and 6B to optimize heterogeneous-granularity signal descriptor, entropy model and sparse-to-dense motion estimator and frame generation model. The corresponding loss objectives in the model training include, but are not limited to, perceptual loss, adversarial loss, identity loss and rate-distortion loss.

By adopting a progressive generative face video compression framework with bandwidth intelligence as described herein, face data is characterized with heterogeneous-granularity representations, where coarse-grained representations can be transmitted in compact signals and fine-grained representations can be transmitted in enriched signals. Conceptually-explicit visual information in a segmentable and interpretable bitstream can be partially transmitted and decoded to implement flexible visual reconstruction at different quality levels, under both low-bandwidth and high-bandwidth conditions.

The proposed progressive framework can outperform reconstruction quality limitations of the existing GFVC algorithms, such as occlusion artifacts, low face fidelity, and poor local motion. Under guidance of enriched visual signals, motion estimation errors from compact representation can be perceptually compensated and long-term dependencies among face frames can be accurately regularized. As a consequence, the enhancement-layer output can greatly improve the reconstruction quality, faithfully representing texture and motion at pixel-level reconstruction.

FIG. 7 illustrates an example system 700 for implementing the processes and methods described above for implementing progressive generative face video compression framework with bandwidth intelligence.

The techniques and mechanisms described herein may be implemented by multiple instances of the system 700 as well as by any other computing device, system, and/or environment. The system 700 shown in FIG. 7 is only one example of a system and is not intended to suggest any limitation as to the scope of use or functionality of any computing device utilized to perform the processes and/or procedures described above. Other well-known computing devices, systems, environments and/or configurations that may be suitable for use with the embodiments include, but are not limited to, personal computers, server computers, hand-held or laptop devices, multiprocessor systems, microprocessor-based systems, set top boxes, game consoles, programmable consumer electronics, network PCs, minicomputers, mainframe computers, distributed computing environments that include any of the above systems or devices, implementations using field programmable gate arrays (“FPGAs”) and application specific integrated circuits (“ASICs”), and/or the like.

The system 700 may include one or more processors 702 and system memory 704 communicatively coupled to the processor(s) 702. The processor(s) 702 may execute one or more modules and/or processes to cause the processor(s) 702 to perform a variety of functions. In some embodiments, the processor(s) 702 may include a central processing unit (“CPU”), a graphics processing unit (“GPU”), both CPU and GPU, or other processing units or components known in the art. Additionally, each of the processor(s) 702 may possess its own local memory, which also may store program modules, program data, and/or one or more operating systems.

Depending on the exact configuration and type of the system 700, the system memory 704 may be volatile, such as RAM, non-volatile, such as ROM, flash memory, miniature hard drive, memory card, and the like, or some combination thereof. The system memory 704 may include one or more computer-executable modules 706 that are executable by the processor(s) 702.

The modules 706 may include, but are not limited to, one or more of a block-based encoder 708, a block-based decoder 710, a heterogeneous-granularity feature extractor 712, a feature coder 714, a feature decoder 716, a dense motion model 718, a deep generative model 720, a neural network trainer 722, a signal compression entropy model 724, a context model 726, a hyper-encoder 728, and a hyper-decoder 730.

The block-based encoder 708 configures the processor(s) 702 to perform block-based coding by techniques and processes described above, such as an encoding process 100 of FIG. 1.

The block-based decoder 710 configures the processor(s) 702 to perform block-based coding by techniques and processes described above, such as a decoding process of FIG. 1.

The feature extractor 712 configures the processor(s) 702 to perform picture coding by techniques and processes described above, such as feature extraction as described above with reference to FIG. 5.

The feature coder 714 configures the processor(s) 702 to perform picture coding by techniques and processes described above, such as feature coding as described above with reference to FIG. 5.

The feature decoder 716 configures the processor(s) 702 to perform picture coding by techniques and processes described above, such as feature decoding as described above with reference to FIG. 5.

The dense motion model 718 configures the processor(s) 702 to perform picture coding by techniques and processes described above, such as computing a relevant sparse motion field and yielding a pixel-wise dense motion map as described above with reference to FIGS. 3, 4, and 5.

The deep generative model 720 configures the processor(s) 702 to perform picture coding by techniques and processes described above, such as reconstructing a reconstructed subsequent picture as described above with reference to FIGS. 4 and 5.

The neural network trainer 722 configures the processor(s) 702 to train any learning model as described herein, such as a feature extractor 612, a reconstructed feature extractor 614, a dense motion model 616, or a deep generative model 618.

The signal compression entropy model 724 configures the processor(s) 702 to perform picture coding by techniques and processes according to example embodiments of the present disclosure as described above with reference to FIGS. 6A and 6B.

The context model 726 configures the processor(s) 702 to perform picture coding by techniques and processes according to example embodiments of the present disclosure as described above with reference to FIGS. 6A and 6B.

The hyper-encoder 728 configures the processor(s) 702 to perform picture coding by techniques and processes according to example embodiments of the present disclosure as described above with reference to FIGS. 6A and 6B.

The hyper-decoder 730 configures the processor(s) 702 to perform picture coding by techniques and processes according to example embodiments of the present disclosure as described above with reference to FIGS. 6A and 6B.

The system 700 may additionally include an input/output (“I/O”) interface 740 for receiving image source data and bitstream data, and for outputting reconstructed frames into a reference frame buffer and/or a display buffer. The system 700 may also include a communication module 750 allowing the system 700 to communicate with other devices (not shown) over a network (not shown). The network may include the Internet, wired media such as a wired network or direct-wired connections, and wireless media such as acoustic, radio frequency (“RF”), infrared, and other wireless media.

Some or all operations of the methods described above can be performed by execution of computer-readable instructions stored on a computer-readable storage medium, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer-readable storage media may include volatile memory (such as random-access memory (“RAM”)) and/or non-volatile memory (such as read-only memory (“ROM”), flash memory, etc.). The computer-readable storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient or non-transitory computer-readable storage medium is an example of computer-readable media. Computer-readable media includes at least two types of computer-readable media, namely computer-readable storage media and communications media. Computer-readable storage media includes volatile and non-volatile, removable and non-removable media implemented in any process or technology for storage of information such as computer-readable instructions, data structures, program modules, or other data. Computer-readable storage media includes, but is not limited to, phase change memory (“PRAM”), static random-access memory (“SRAM”), dynamic random-access memory (“DRAM”), other types of random-access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. A computer-readable storage medium employed herein shall not be interpreted as a transitory signal itself, such as a radio wave or other free-propagating electromagnetic wave, electromagnetic waves propagating through a waveguide or other transmission medium (such as light pulses through a fiber optic cable), or electrical signals propagating through a wire.

The computer-readable instructions stored on one or more non-transient or non-transitory computer-readable storage media that, when executed by one or more processors, may perform operations described above with reference to FIGS. 1-6B. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A computing system, comprising:
one or more processors, and
a computer-readable storage medium communicatively coupled to the one or more processors, the computer-readable storage medium storing computer-readable instructions executable by the one or more processors that, when executed by the one or more processors, perform associated operations comprising:
extracting a key-reference feature having a granularity of a plurality of granularities from a decoded key frame of the video sequence;
generating a dense motion map and an occlusion map based on the key-reference feature and based on an inter frame feature of a plurality of inter frames of the video sequence, wherein the key-reference feature and the inter frame feature have a same granularity; and
reconstructing the video sequence based on the decoded key frame, the dense motion map and the occlusion map by a generative face video compression (“GFVC”) model.

2. The computing system of claim 1, wherein extracting the key-reference feature having a granularity of a plurality of heterogeneous granularities comprises:
selecting the granularity of the plurality of heterogeneous granularities based on available bitrate for transmission in a bitstream.

3. The computing system of claim 1, wherein the operations further comprise:
reconstructing the decoded key frame from a transmitted bitstream; and
outputting a decoded inter frame feature having the granularity from a transmitted bitstream.

4. The computing system of claim 1, wherein extracting the key-reference feature having a granularity of a plurality of granularities comprises down-sampling the decoded key frame and the plurality of inter frames.

5. The computing system of claim 4, wherein extracting the key-reference feature having a granularity of a plurality of granularities further comprises transforming the decoded key frame and the plurality of inter frames to a high-dimensional face feature map.

6. The computing system of claim 5, wherein extracting the key-reference feature having a granularity of a plurality of granularities further comprises performing a multi-level nonlinear transformation upon the high-dimensional face feature map.

7. The computing system of claim 6, wherein extracting the key-reference feature having a granularity of a plurality of granularities further comprises performing richer convolutional architecture and Generalized Divisive Normalization (“GDN”) upon the high-dimensional face feature map.

8. A computing system, comprising:
one or more processors, and
a computer-readable storage medium communicatively coupled to the one or more processors, the computer-readable storage medium storing computer-readable instructions executable by the one or more processors that, when executed by the one or more processors, perform associated operations comprising:
compressing a key frame of a video sequence;
extracting an inter frame feature having a granularity of a plurality of granularities from a plurality of inter frames of the video sequence; and
entropy-coding and transmitting the compressed key frame and the inter frame feature in a bitstream.

9. The computing system of claim 8, wherein extracting the inter frame feature having a granularity of a plurality of heterogeneous granularities comprises:
selecting the granularity of the plurality of heterogeneous granularities based on available bitrate for transmission in a bitstream.

10. The computing system of claim 8, wherein extracting the inter frame feature having a granularity of a plurality of granularities comprises down-sampling the compressed key frame and the plurality of inter frames.

11. The computing system of claim 10, wherein extracting the inter frame feature having a granularity of a plurality of granularities further comprises transforming the compressed key frame and the plurality of inter frames to a high-dimensional face feature map.

12. The computing system of claim 11, wherein extracting the key-reference feature having a granularity of a plurality of granularities further comprises performing a multi-level nonlinear transformation upon the high-dimensional face feature map.

13. The computing system of claim 12, wherein extracting the key-reference feature having a granularity of a plurality of granularities further comprises performing richer convolutional architecture and Generalized Divisive Normalization (“GDN”) upon the high-dimensional face feature map.

14. A computing system, comprising:
one or more processors, and
a computer-readable storage medium communicatively coupled to the one or more processors, the computer-readable storage medium storing computer-readable instructions executable by the one or more processors that, when executed by the one or more processors, perform associated operations comprising:
decoding a coded bitstream to reconstruct an auxiliary facial signal of a granularity of a plurality of granularities based on a learned Gaussian distribution, wherein the auxiliary facial signal comprises a feature extracted from a key frame or a plurality of inter frames of a video sequence;
wherein the learned Gaussian distribution comprises outputs of a context model, a hyper-encoder, and a hyper-decoder.

15. The computing system of claim 14, wherein an output of the hyper-encoder and the hyper-decoder comprises a hyperprior predicted from a facial signal of the key frame.

16. The computing system of claim 14, wherein an output of the context model comprises a causal context of quantizing the auxiliary facial signal.

17. The computing system of claim 14, wherein an output of a context model comprises a reconstructed variance of the Gaussian distribution, wherein the variance of the Gaussian distribution is transmitted in the coded bitstream.

18. The computing system of claim 14, wherein decoding the coded bitstream comprises decoding a difference between the auxiliary facial signal and a facial signal of the key frame.

19. The computing system of claim 18, wherein the operations further comprise:
up-scaling the key frame and the plurality of inter frames; and
calculating a difference between motion information of the up-scaled key frame and motion information of the plurality of inter frames.

20. The computing system of claim 19, wherein the operations further comprise:
calculating a sparse motion map based on the key frame and the plurality of inter frames;
generating a coarse deformed frame from the sparse motion map;
concatenating the difference with the coarse deformed frame; and
estimating a dense motion map and an occlusion map from the concatenated difference and coarse deformed frame.
